(19) United States
(12) Patent Application Publication
(10) Pub. No.: US 2004/0049583 A1
(43) Pub. Date: Mar. 11, 2004

(54) Internet communication system

(76) Inventor: Robert MacFarlane, Lachine (CA)

Correspondence Address: BROUILLETTE KOSIE, 25th Floor, 1100 Rene-Levesque Boulevard West, Montreal, QC, H3B 5C9, CA

(21) Appl. No.: 10/236,965

(22) Filed: Sep. 9, 2002

(51) Int. Cl. G06F 15/16

(52) U.S. Cl. 709/228; 709/203

(57) ABSTRACT

The present invention concerns an Internet communication system in a network for the hospitality industry and which uses the existing telephone system, a dial tone generating device and a server. The network allows multiple users to have access to Internet services at the same time with the connection of their personal computer to the network, with no modification to the Internet set-up configuration. The exterior public telephone lines are bypassed, thereby avoiding the paralysis of the establishment's telephone system.

### FIELD OF INVENTION

The present invention concerns an Internet communication system in a network for the hospitality industry and which uses the existing telephone system, a dial tone generating device and a server, thereby avoiding the paralysis of the establishment's telephone system.

### BACKGROUND OF THE INVENTION

In the hospitality industry, various solutions have been developed in the past to offer Internet services to users located in public places, such as hotels, governmental buildings, hospitals, or convention centers. However, most of these solutions involve high-speed connectivity and are based on cabling, DSL technology, and wireless links. These solutions require important investments to the owner of the establishment, in order to provide each location where the Internet service access is offered with the required equipment and connections.

These technologies, in some cases, do use the establishment's telephone lines or cabling, but the telephone system equipment that is already installed in the establishment is not completely involved. For instance, a PBX system (private branch exchange), which is commonly found in hotels as part of the telephone system, acts as a telephone central office. The PBX manages call requests between telephone users in each rooms to share a certain number of external telephone lines, which is usually less than the number of rooms in the hotel. In Miron et al. (U.S. Pat. No. 6,034,992), the connection system makes use of the existing telephone wiring, but necessitate the addition of an analog front end to the server which provides digital to analog conversion means, in order to maximize the speed of communication. Since no PBX system is involved in the solution, the owner of that system needs to purchase new material. He would also need to install and adapt it to what is kept from his original internal telephone system and computer network, which usually results in a more expensive solution than to use existing in house equipment.

Another alternative to offer Internet access to hospitality establishments consist in using multiple devices, including a Router and a Remote Access Server, which often results in a cumbersome and expensive solution. The above also requires that a computer networking specialist designs, builds and configures the solution.

To get access to the Internet, each user PC must be previously configured with a unique address. A computer wishing to communicate with another computer in the same local area network usually directs a message to a server by using this unique address. The server in the local area network recognizes the address and processes the message to the computer being part of the same local area network, or sends it to the Internet in the case of a foreign address. Slemmer et al. (U.S. Pat. No. 6,377,990) proposes a local area network having a server and a plurality of user computers. The system provides a network adaptor address on top of the computer's unique Internet address which is recognized by the local area network server. However, this invention takes as a premise that the Internet connection is already made between the foreign user computer and the receiving local area network.

This invention provides means to integrate any user PC to a network in a hospitality establishment, requiring no other action from the user than to physically connect his computer to the network and put up a request for the Internet services. The Internet connection is made possible by using the existing telephone system equipment, which contributes in establishing the Internet connection, regardless of the Internet configuration of the user PC. For instance, the user PC may join the hospitality network equipped with a modem or not, may be configured with an Internet analog or digital default set-up. This invention comprises means to connect to the Internet for both analog and digital modes.

### SUMMARY OF THE INVENTION

It is an object of the present invention to provide an Internet communication system which provides means to integrate any user PC to an in house network destined to offer Internet access to the clients in the hospitality industry.

It is further an object of this invention to offer a transparent solution to the users of the hospitality establishment, requiring no other action from the user than to physically connect his computer to the network and put up a request for the Internet services.

It is further an object of this invention to use the existing telephone system equipment which contributes in establishing the Internet connection, regardless of the Internet configuration of the user PC.

It is further an object of this invention to provide means to allow the user PC to join the hospitality network and to connect to the Internet for both analog and digital modes. The analog mode implicates the use of a modem on the user PC. The digital instance is required in the case of a user PC equipped with a network interface card.

It is further an object of this invention to modify the BARS instructions from the existing PBX telephone system and also to add a dial tone generating device and an off-hook detector circuit to the existing PBX telephone system in the analog mode of operation.

There is therefore provided an improved hospitality communication system for use in a network, which network comprises a first user PC equipped with communication means, a first connector, a first connection interface destined to connect the said first PC to the said network with the use of said first connector, an Internet connectivity line which links said network to the Internet, wherein the improvement comprises:

a remote access server comprising network access means, remote access means and which is directly connected to the Internet;

an operating system software installed on the said server to provide information required for the Internet connection;

an in house switching telephone system comprising means to manage an existing telephone network to provide a communication channel to said first user PC;

a dialtone generating device which is connected to the said in house switching telephone system and the said remote access server.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE DRAWINGS

FIG. 1 is a schematic view showing the connections of each components of the hospitality remote access communication network in accordance with the invention.

### DETAILED DESCRIPTION OF A PREFERRED EMBODIMENT

The first embodiment of this invention represents a communication system in a network for use in a public building, like a hotel. The system comprises components that provide Internet access services to clients or users, requiring no other action than to put up a request on a computer. In a preferred embodiment, this invention uses the entire existing telephone network and thereby avoids the telephone system paralysis, caused by users dialing Internet Service Providers during peak period of use of the telephone system.

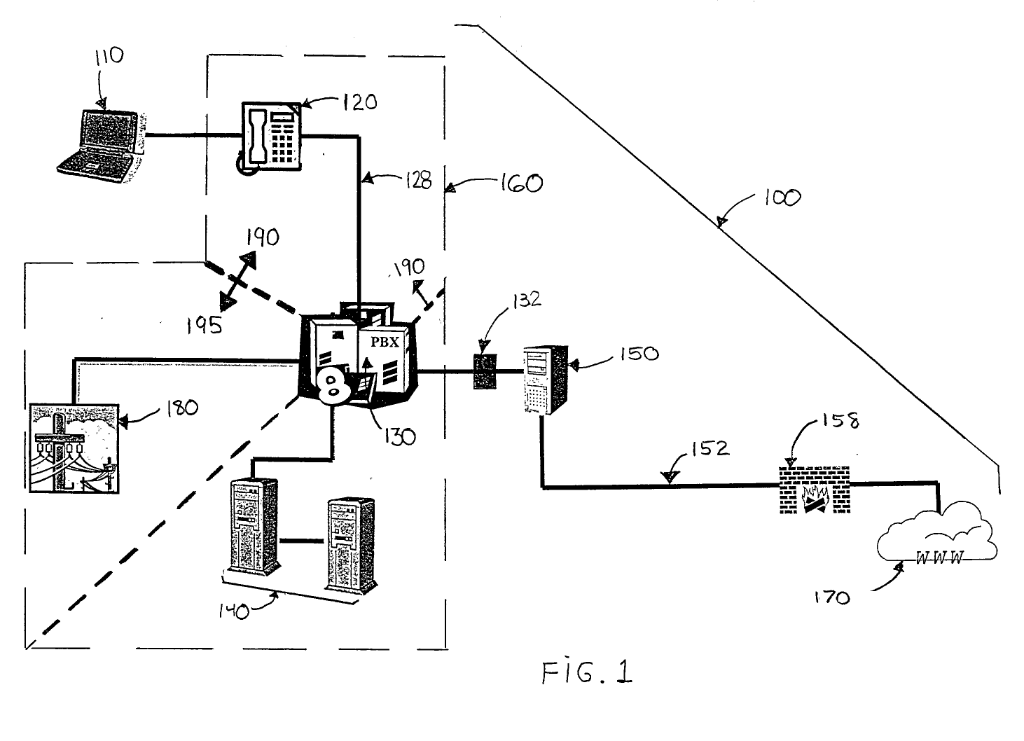

As seen in FIG. 1, the user PC 110 needs to be connected to the network 100 to have access to the Internet 170. In the preferred embodiment of this invention, the user brings his own user PC 110, being configured with its own Internet address that uniquely identifies each sender or receiver of information on the Internet 170. In another embodiment, the hotel provides some rooms with a computer offering direct Internet services to the client.

Each hotel telephone network 160 usually comprises a telephone 120 in each room which is connected with wires (not shown) and via a data connector (not shown). When a hotel client picks up the telephone 120 and composes a request by dialing a telephone number, a PBX (private branch exchange) 130 acts as a telephone central office which manages call requests between telephone users on internal lines 128 while allowing all users to share a certain number of external telephone lines 180. The main purpose of a PBX 130 is to save the cost of requiring an external telephone line 180 for each user.

According to this invention, the user PC 110 is connected to the telephone network 160 by the same data connector (not shown) as the hotel telephone 120, thus enabling the hotel owner to use the PBX 130 managing capabilities and the call accounting system 140 to process the Internet requests and bill the user accordingly.

The Internet access is made possible because a server 150 receives the Internet request from the PBX 130 and redirects it to the Internet 170, preferably via a high speed connection 152 which is independent from the telephone network 160 and through a firewall protection 158.

Once a request for the Internet 170 is placed from a user PC 110, the communication between the server 150 and the PBX 130 is ensured with the help of their computer cards (not shown).

The server 150 is equipped with a remote access card (not shown) which includes both the digital cards (not shown) and the analog cards (not shown). These cards are each configured in a different way to achieve the Internet connection, depending on the method of the Internet request, which comes from the user PC 110.

The PBX 130 comprises a digital card (not shown) and an analog card (not shown). In the case of an analog request from a user PC 110, which is equipped with a modem, the PBX 130 redirects the connection request to the server 150 via the analog line (not shown) through a dialtone generating device 132. The dialtone generating device 132 signals to the modem (not shown) of the user PC 110 the presence of an available line with a steady tone, thus allowing the user PC 110 modem to complete the request.

Both the digital and analog configurations are required in order to allow system flexibility to the owner of the hotel and system transparency to the user of the Internet service, regardless of the mode of operation of his user PC 110. In the first embodiment, the user connects his user PC to the network 100 and sends a request for Internet services without changing his usual Internet set-up. The user PC 110 is either configured to work in a network with a digital Internet set-up, like in most office buildings, or work in an analog mode when equipped with a modem, for typical personal or home Internet set-up.

In the digital instance, the digital card (not shown) of the PBX 130 and the card on the digital remote access card (not shown) of the server 150 are configured to ensure proper interoperability between the PBX 130 and the server 150. The cards do not negotiate their settings but remain fixed and communicate digital information from the user PC 110 to the Internet via the PBX 130 and the server 150. The request to access the Internet 170 gets processed, then a connection to the Internet 170 is obtained via the high speed Internet connectivity 152.

In case of an analog setting of the user PC 100, the PBX 130 redirects the connection request through the analog card (not shown) to the dialtone generating device 132, which emulates a dial tone that is perceived by the modem as a signal to start the the connection process. Once the connection process has begun, the analog card (not shown) in the server 150 completes the connection link procedure. By being connected to the network 100, each modem of every user PC 110 becomes an extension in a group that can access the Internet 170.

To avoid any modification to the user PC 110 in case of an analog configuration, the BARS (Automatic Route Selection, not shown) in the PBX 130 is used and modified. The BARS is a list of instructions that are used for the routing of calls. For example, a BARS in a telephone network 160 can be programmed so that if someone dials 555 on an extension, the call would be redirected to an external telephone number such as 1-888-555-2525, and vice-versa.

According to this invention, the BARS in the PBX 130 is programmed to include all the Internet service provider telephone numbers that can be dialed by modems of user PC 110 in analog configurations. However, the BARS features are only available on the trunk side 190 of the PBX 130. The trunk side 190 of a telephone network 160 comprises the shared lines carrying the voices and data which terminate at the PBX 130. The other side between the PBX 130 and the external telephone lines 180 is called the public side 195.

In order to compensate for the lack of dial tone on the trunk side 190 of an internal telephone network 160, the addition of a dial-tone generating device 132 is necessary. When an Internet request is placed through the PBX 130 in the analog case, an automatic routing system executes this request by opening a line 128 on the trunk side 190 of the telephone network 160. No dial tone sound is yet sensed by the modem of the user PC 110, which would eventually results in the failure of the Internet dial-up connection request. The Remote Access card of the server 150 cannot maintain an open line connection for the purpose of “listening” in an analog state before a connection has been established.

The dialtone generating device 132 includes an off-hook detector circuit (not shown) which acts as a bridge by making the connection between the analog card of the PBX 132, on the trunk side 190 of the telephone system 160, and the analog remote access card of the server 150. The off-hook detector circuit (not shown) is activated when the automatic routing system opens a line 128 on the trunk side 190 in the case of an analog Internet request from the user PC 110. The electronic control circuit of the off-hook detector circuit (not shown), which gives the indication of the off-hook status, thereby generates a dial-tone connection to the Remote Access Card. The modem of the user PC 110 therefore believes that a dial tone is available, which is required to simulate the connection with the Remote Access Server. Upon termination of this link, the off-hook detector circuit (not shown) severs the connection between the analog card of the PBX 130, on the trunk side 190 of the telephone system 160, and the analog remote access card of the server 150, rendering the line back to “listening” mode.

A software (not shown) on the server 150 works as a gateway which allows multiple connections to the network 100 to share one single line to an external network, like a high speed connection line 152 to the Internet 170. An identification is provided to the first user PC as a temporary member of the communication network 200 to allow incoming and outgoing Internet information to travel through this open communication channel. The network 200 connection to the Internet is ensured with the help of a network card (not shown) on the server 150.

In a second embodiment, the Internet request can be processed by including in the Internet set-up of the user PC 110 which is equipped with a modem, the particular extension allocated to the room where the user PC 110 is connected to, before the modem dials its usual Internet service provider telephone number. This embodiment could be used in rooms where user PC 1 10 are already provided in the hotel room or with Internet user which are familiar with modifications to the Internet set-up.

Although the invention has been described above with respect with one specific form, it will be evident to a person skilled in the art that it may be modified and refined in various ways. It is therefore wished to have it understood that the present invention should not be limited in scope, except by the terms of the following claims.

1. An improved hospitality communication system for use in a network, which network comprises a first user PC equipped with communication means, a first connector, a first connection interface destined to connect the said first PC to the said network with the use of said first connector, an Internet connectivity line which links said network to the Internet, wherein the improvement comprises:
a remote access server comprising network access means, remote access means and which is directly connected to the Internet;
an operating system software installed on the said server to provide information required for the Internet connection;
an in house switching telephone system which comprising means to manage an existing telephone network to provide a communication channel to said first user PC;
a dialtone generating device which is connected to the said in house switching telephone system and the said remote access server.

2. An improved hospitality communication system, as claimed in claim 1, wherein the communication means of the first user PC is a modem.

3. An improved hospitality communication system, as claimed in claim 1, wherein the communication means of the first user PC functions in the digital mode.

4. An improved hospitality communication system, as claimed in claim 1, wherein more than one user PC are linked to the said network, each being equipped with communicating means and each having its own connector and connection interface.

5. An improved hospitality communication system, as claimed in claim 2, wherein the in house telephone switching system is a Private Branch eXchange system (PBX).

6. An improved hospitality communication system, as claimed in claim 5, wherein the Private Branch eXchange system (PBX) includes a list which contains all known telephone numbers to get access to the Internet.

7. An improved hospitality communication system, as claimed in claim 6, wherein an off-hook detector circuit in the dial tone generating device acts as a bridge between the Private Branch eXchange system (PBX) and the server.

8. An improved hospitality communication system, as claimed in claim 7, wherein the off-hook detector circuit allows for a dial tone signal to reach the modem of the first user PC.

9. An improved hospitality communication system, as claimed in claim 1, wherein said in house remote access server connects to the Internet through high speed.

10. An improved hospitality communication system, as claimed in claim 1, wherein said remote access communicator comprises an analog remote access card and a digital remote access card.

11. An improved hospitality communication system, as claimed in claim 1, wherein said network access means is a network card.

12. A method for establishing an Internet connection by using an improved hospitality communication system comprising the following steps:
a) Physical connection of a first user PC to a connection interface with a connector;
b) Internet connection request transmitted from said first user PC to a Private Branch eXchange system (PBX);
c) Transmission of the Internet connection request to a remote access server and via a dialtone generating device;
d) Identification provided to the said first user PC from an operating software of the said server;
e) Access of said first user PC to the Internet;
f) Connection to the Internet services.

13. A method for establishing an Internet connection by using an improved hospitality communication system, as claimed in claim 12, wherein multiple user PC can follow said method at the same time.
